(19) United States
(12) Patent Application Publication
(10) Pub. No.: US 2016/0257351 A1
(43) Pub. Date: Sep. 8, 2016

(54) TRUCK COMPARTMENT ATTACHMENT ASSEMBLY AND METHOD

(71) Applicant: Stahl/Scott Fetzer Company, Wooster, OH (US)

(72) Inventor: THOMAS J. BOYER, Wooster, OH (US)

(21) Appl. No.: 15/058,604

(22) Filed: Mar. 2, 2016

Related U.S. Application Data
(60) Provisional application No. 62/126,763, filed on Mar. 2, 2015.

(51) Int. Cl. B62D 29/04; B60R 9/06

(52) U.S. Cl. CPC B62D 29/043; B60R 9/065

(57) ABSTRACT

A method and attachment assembly for securing a polymeric compartment arrangement to a cross channel of a truck bed. The attachment assembly includes a body member transversely extending from a support flange. The support flange comprises first and second slots for engaging a cross channel of a track bed and the body member includes a plurality of apertures for receiving fasteners for securing the body member to a compartment arrangement. The body member manufactured from a first material and the support flange manufactured from a second material, wherein the first material is different from the second material.

### CROSS REFERENCES TO RELATED APPLICATIONS

The following application claims priority under 35 U.S.C. 119(e) to co-pending U.S. Provisional Patent Application Ser. No. 62/126,763 filed Mar. 2, 2015 entitled TRUCK COMPARTMENT ATTACHMENT ASSEMBLY AND METHOD. The above-identified application is incorporated herein by reference in its entirety for all purposes.

### TECHNICAL FIELD

The present disclosure relates to a truck compartment attachment assembly and method, and more particularly, an attachment assembly that couples truck compartments constructed of nonmetallic materials to a metal frame of a truck.

### BACKGROUND

There exists a need to attach storage compartments to heavy-duty automobiles, heavy-duty trucks, service body trucks, dump body trucks, chip body trucks; and other vehicles, (collectively hereinafter “trucks”). An example showing such compartments on a light-weight truck can seen in U.S. Design Pat. No. D342.930 that issued on Jan. 4, 1994 (hereinafter “the '930 Patent”). The '930 Patent is owned by the assignee of the present application and is incorporated herein by reference in its entirety.

Conventional storage compartments are made of metal such as aluminum or steel. Today, there is a desire to reduce weight of components on trucks and automobiles in order to increase fuel economy. One possible solution is to make the storage compartments from lightweight polymeric material, such as plastic, polypropylene, and the like. Additionally, such lightweight material is typically less expensive than the conventional metal storage compartments.

### SUMMARY

One example embodiment of the present disclosure includes a method and attachment assembly for securing a polymeric compartment arrangement to a cross channel of a truck bed. The attachment assembly includes a body member transversely extending from a support flange. The support flange comprises first and second slots for engaging a cross channel of a truck bed. The body member includes a plurality of apertures for receiving fasteners for securing the body member to a compartment arrangement. The body member is manufactured from a first material and the support flange is manufactured from a second material. The first material is different from the second material.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is an perspective view of a truck bed constructed in accordance with one example embodiment of the present disclosure;

FIG. 2 is a bottom plan view of FIG. 1;

FIG. 3 is a top plan view of FIG. 1;

FIG. 4 is a right side elevation view of FIG. 1;

FIG. 5 is a left side elevation view of FIG. 1;

FIG. 6 is a front elevation view of FIG. 1;

FIG. 7 is a rear elevation view of FIG. 1;

FIG. 8 is a first inverted perspective view of FIG. 1;

FIG. 9 is a second inverted perspective view of FIG. 1;

FIG. 10 is a perspective view of the truck bed of FIG. 8 before the compartment assemblies are attached thereto in accordance with one example embodiment of the present disclosure;

FIG. 11 is a perspective view of the truck bed of FIG. 9 before the compartment assemblies are attached thereto in accordance with one example embodiment of the present disclosure;

FIG. 12 is a perspective view of FIG. 1 before the compartment assemblies are attached thereto in accordance with one example embodiment of the

present disclosure;

FIG. 13 is a second perspective view of FIG. 12;

FIG. 14 is an exploded view of a compartment attachment assembly being secured to a transverse truck member, the compartment attachment assembly being constructed in accordance with one example embodiment of the present disclosure; and

FIG. 15 is a compartment attachment assembly secured to a transverse truck member, the compartment attachment assembly is constructed in accordance with one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a truck compartment attachment assembly and method, and more particularly, an attachment assembly that couples truck compartments constructed of nonmetallic materials to a metal frame of a truck.

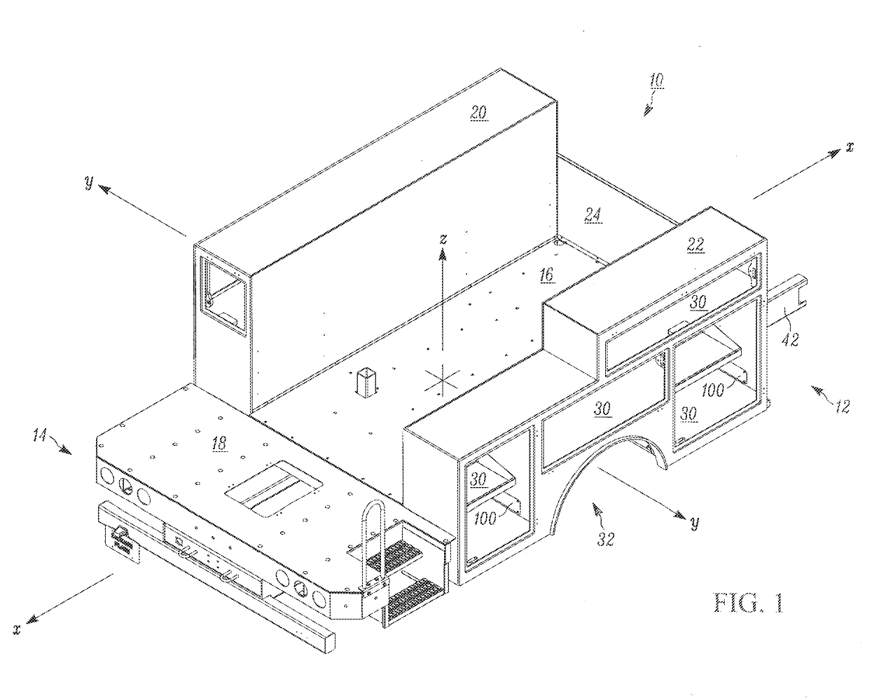

FIG. 1 illustrates a truck bed 10 constructed in accordance with one example embodiment of the present disclosure. The truck bed 10 is orthogonally divided about a longitudinal axis X, a lateral axis Y, and a medial axis Z. Extending along the longitudinal axis X of the truck bed 10 is the bed's front end 12 and rear end 14. The truck bed 10 further comprises a bed 16, a rear platform 18, and first and second compartment arrangements 20, 22, respectively. Extending laterally and spacing the compartment arrangements 20, 22 at the front end 12 is a firewall 24.

The compartment arrangements 20, 22 comprise a plurality of storage areas 30. Each of the storage areas have unlimited shapes and sizes. For illustrative purposes, the storage areas 30 do not have doors, but it would be appreciated that doors would be added later in the assembly process. In the illustrated example embodiment, the compartment arrangements 20, 24 are made from a polymeric material such as plastic, polypropylene, and the like. In another example embodiment, the compartment arrangements 30 are made from molded polypropylene. The compartment arrangements 20, 24 each comprise a respective wheel well 32. in an alternative example embodiment (not shown), the compartments sit directly above the axles and tires such that a wheel well is not provided.

The truck bed 10 is constructed such that it would be attached to a motorized vehicle, having an engine, cab, and body, as would be appreciated by those of ordinary skill in the art. The truck bed 10 is further adapted to attach to heavy-duty automobiles, heavy-duty trucks, service body trucks, dump body trucks, chip body trucks, and other vehicles, (collectively hereinafter “trucks”).

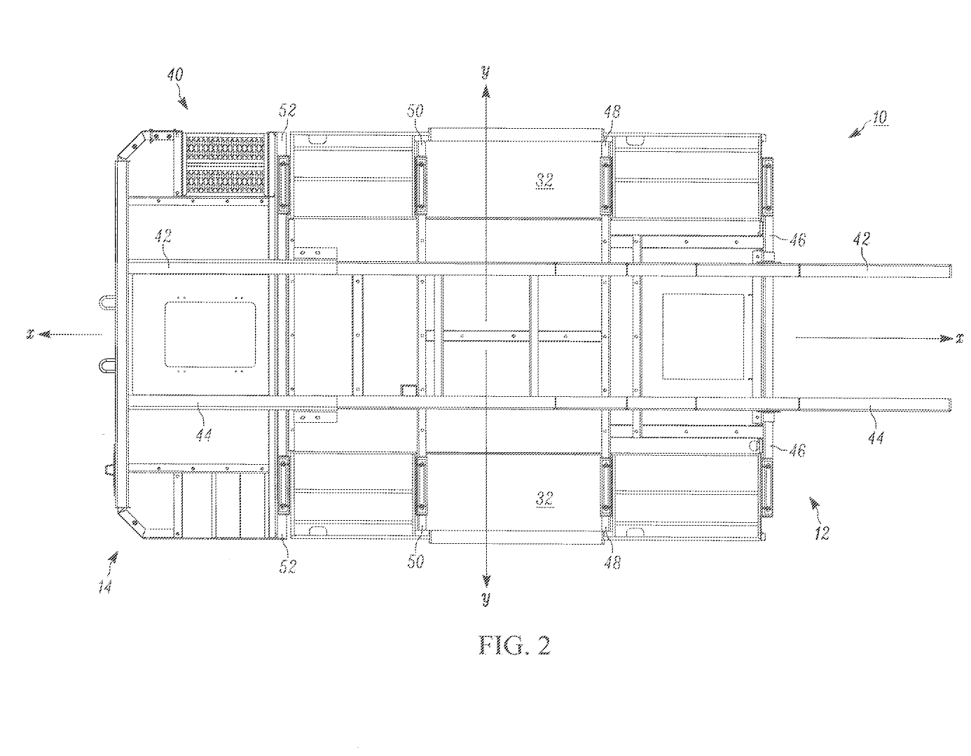

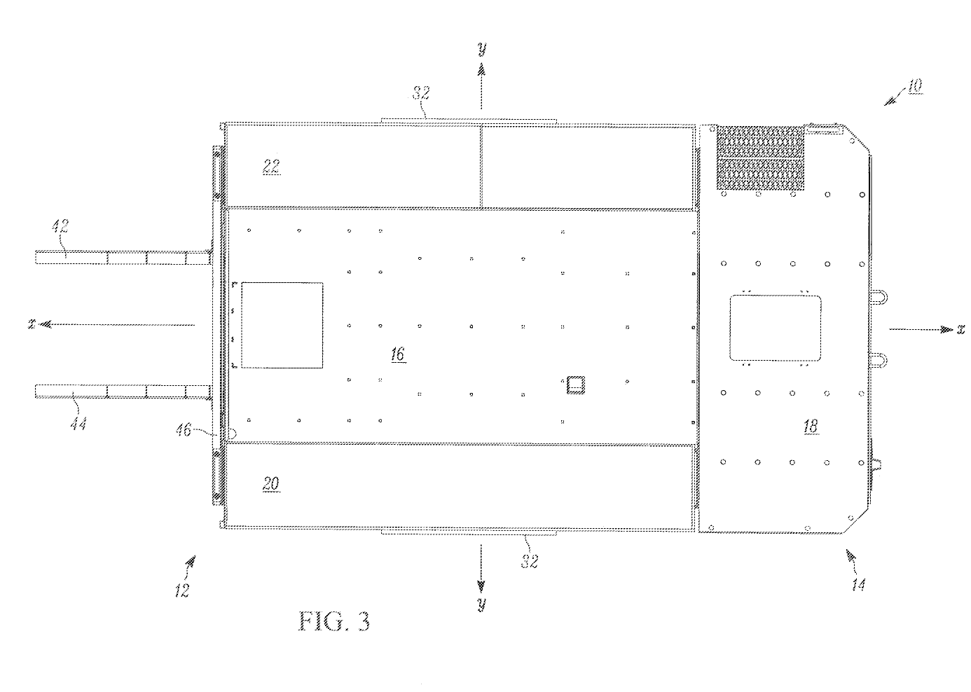

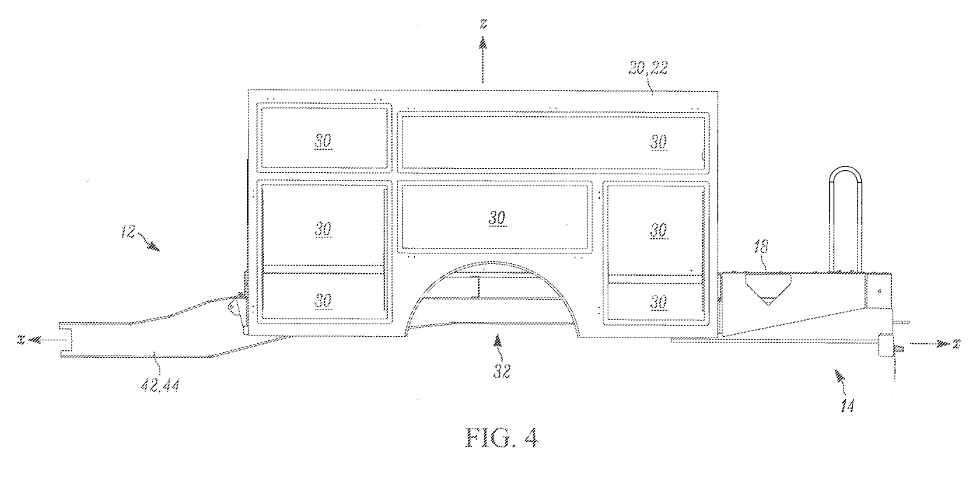

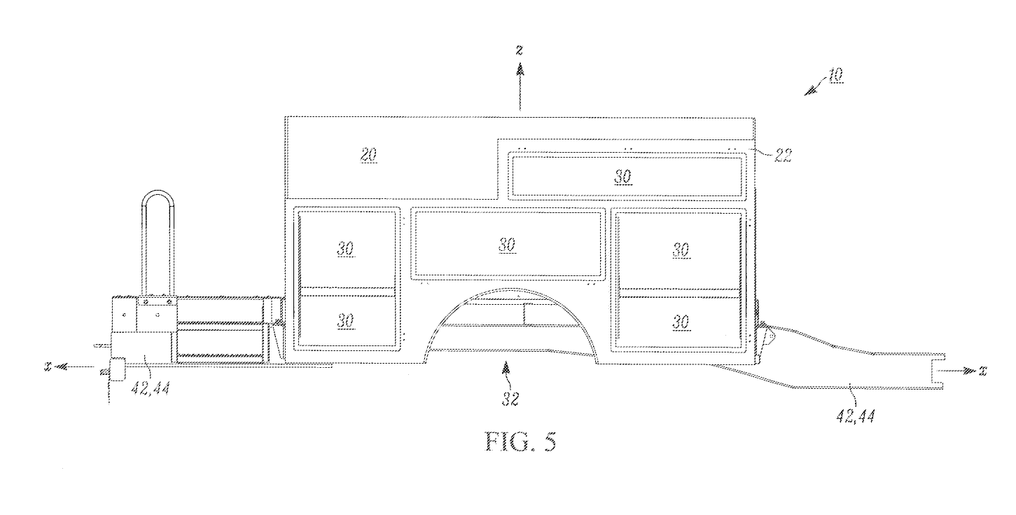

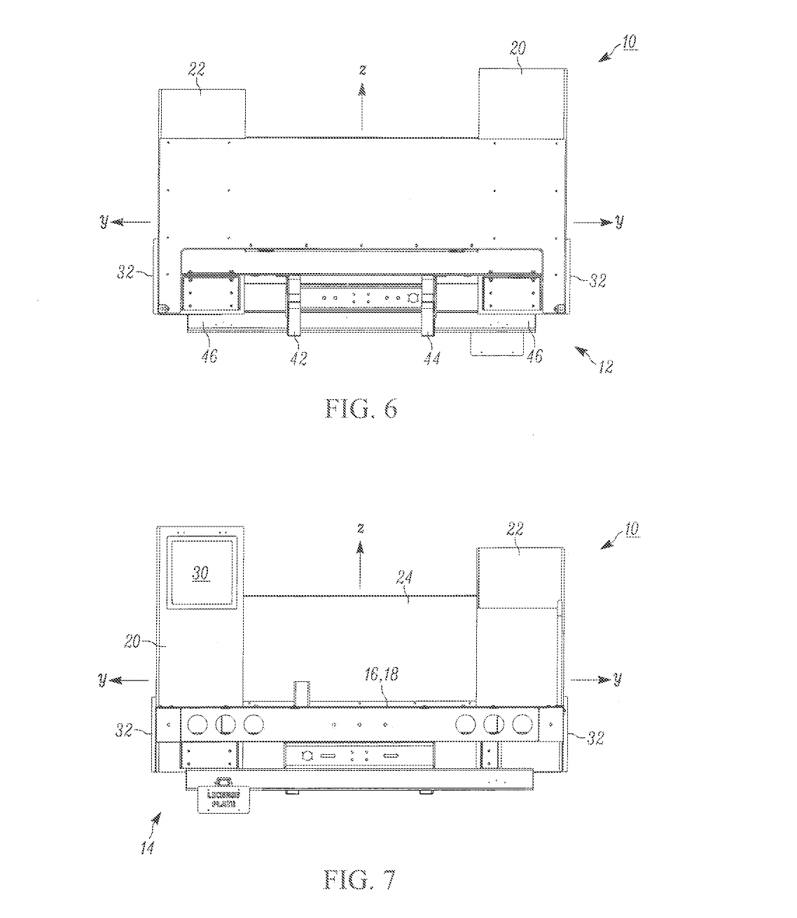

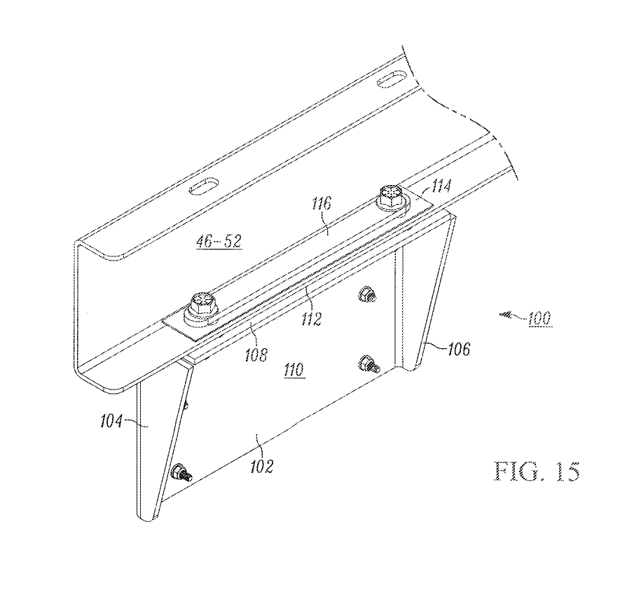

Referring now to FIG. 2, a bottom plan view of the truck bed 10 illustrated in FIG. 1 is shown. The truck bed 10 additionally comprises a frame support structure 40 extending parallel to the longitudinal axis X and having first and second frame rails 42 and 44, respectively. Each rail 42, 44 is coupled to four cross channels 46, 48, 50, and 52 that are transversely disposed about each rail. In the illustrated example embodiment, the channels 46-52 are parallel with the axis Y. The frame rails 42, 44 are made from steel, while the cross channels 46-52 are made from metal such as steel or aluminum. In one example embodiment, the cross channels 46-52 are s-channels or e-channels, as illustrated in FIGS. 14-15.

The frame rails 42, 44 can extend the entire length of the bed 16 and

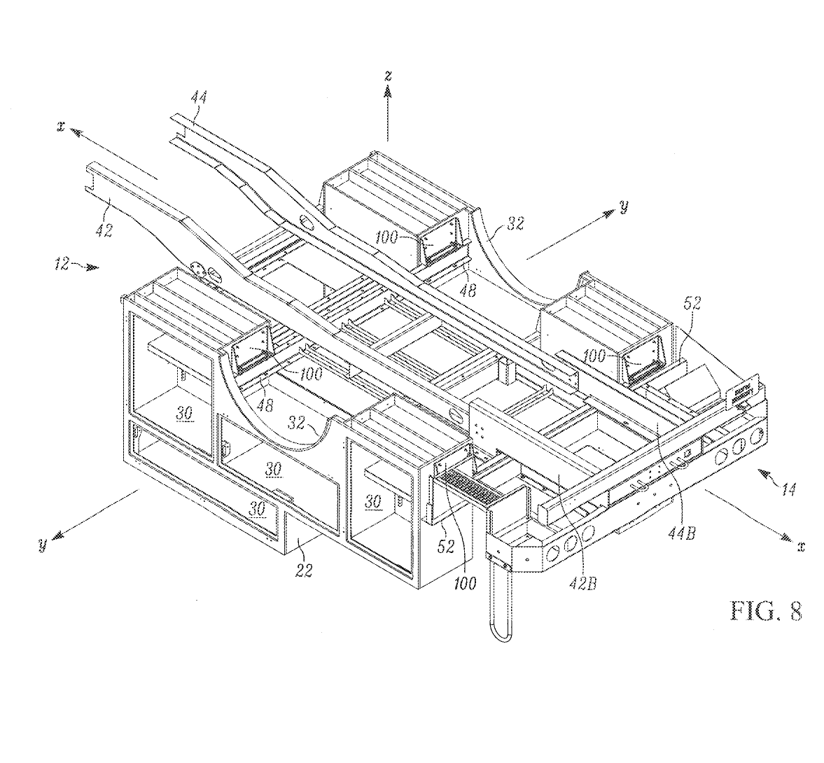

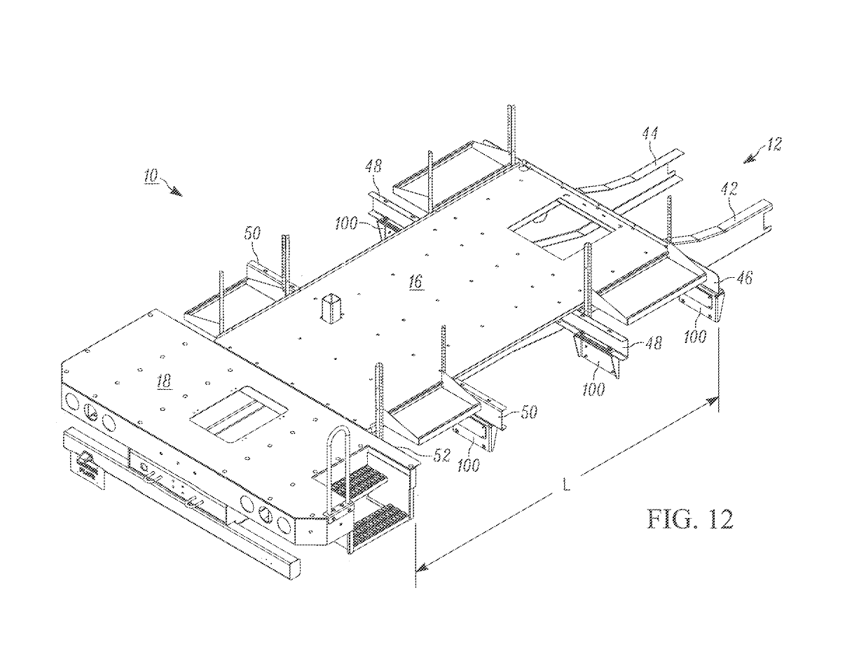

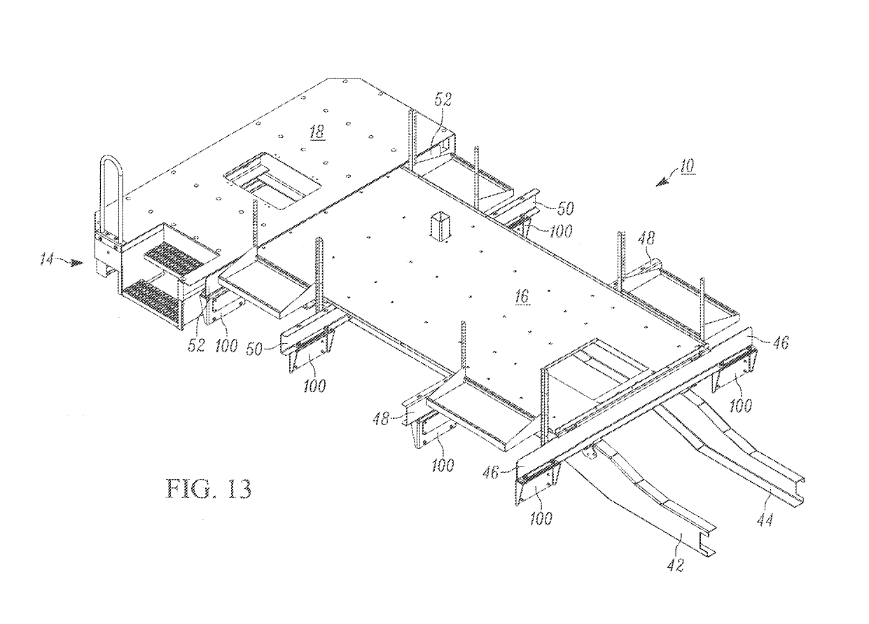

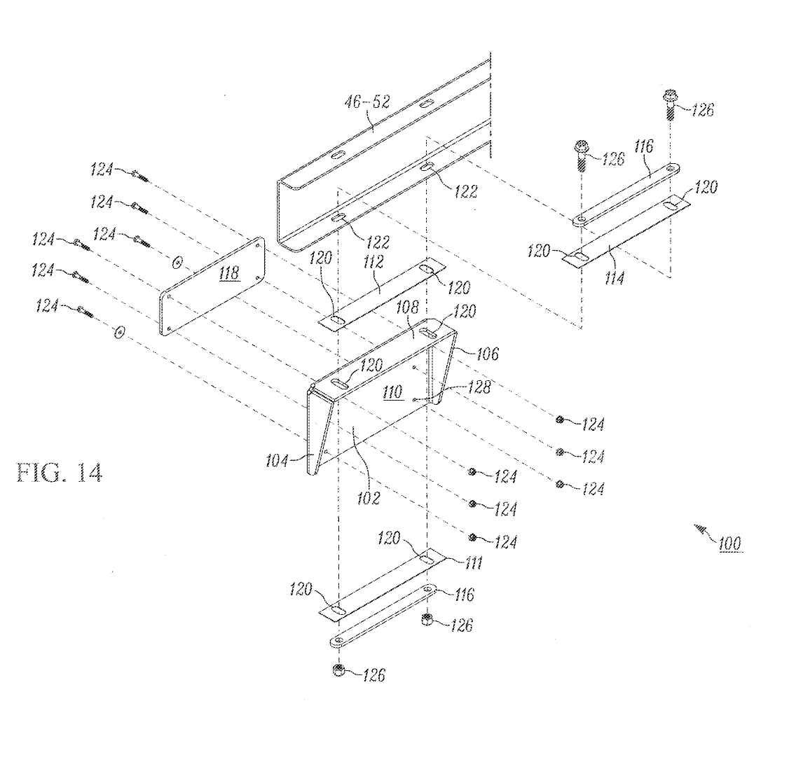

protrude out the front end 12. Alternatively, the frame rails 42, 44 could be coupled by welding or fasteners to extension rails 4213 and 44B, as illustrated in FIG. 8. The extension rails 42B, 44B, further support the rear platform 18. As can be seen in FIGS. 12 and 13, the bed 16 and the rear platform 18 are attached to the cross channels 46-52, which in turn are attached to the frame rails 42,44.

Because the storage compartment arrangements 20, 22 are molded from polymeric material such as polypropylene, the thermal coefficient of thermal expansion is very high relative to the thermal coefficient of thermal expansion of the metal cross channels 46-52. It is not unusual for the truck beds 10 to be exposed to geographical areas that have variations in temperature in excess of one hundred degrees Fahrenheit (100° F.). In the illustrated example embodiment, the compartment arrangements 20, 22 are each molded as a single piece, in an alternative example embodiment (not shown), the compartment arrangements 20, 22 comprise several individual storage boxes coupled together. Under either compartment arrangement 20, 22 construction, such range in temperature is problematic, since the compartments would expand or contract at significantly different rates than the expansion of the metal longitudinal rails 40, 42 and the metal cross channels 46-52. As such, the compartments would be subject to extreme buckling and/or fracturing. Dimension in the example embodiment of FIG. 12 extending from cross member 46 to 52 is approximately one hundred inches (100″) in length. Such lengths will result in a thermal expansion difference greater than one inch (1″) between the rails 42, 44, their cross members 46-52 and the compartment arrangements 20, 22.

This problem of buckling and/or fracturing from dissimilar materials is advantageously resolved by an attachment assembly 100 (see FIGS. 14 and 15) that acts as a buffer in securing the compartment arrangements 20, 22 to the cross channels 46-52. FIGS. 14 and 15 illustrate a single attachment assembly 100 being secured to a cross channel 46-52.

The attachment assembly 100 comprises a body member 102 formed by two gussets 104, 106 spaced by a support flange 108, collectively connected to a support plate 110. The support flange 108 transversly extends from the body member 102. In the illustrated example embodiment, the support flange 108 is orthogonal to the support plate 110.

Additionally making up the attachment assembly 100 are first, second, and third flange plates 111, 112, 114, locking plates 116, and a backing plate 118. The body member 102, the gussets 104, 106, the backing plate 118, and the locking plate 116 are all made from metal, such as steel or aluminum and accordingly provide strength to the attachment assembly 100. The support flange 108 and the flange plates 111, 112, and 114 are all manufactured from polymeric material having a same coefficient of thermal expansion as the compartment arrangements 20, 22, thus allowing for thermal expansion and contraction of the compartment arrangements 20, 22 relative to the cross channels 46-52.

Also allowing for the differences in the expansion rates is the orientation of slots 120 located in the support flange 108 and the first second, and third flange plates 111, 112, and 114, During assembly the slots 120 are substantially concentrically aligned between the support flange 108, and the flange plates 111, 112, and 114, The slots 120 are u-shaped or elliptical slots that extend in the direction of the longitudinal axis X. The slots 120 and polymer material of the support flange 108 and the flange plates, 111, 112, and 114 provide for relative expansion and contraction of the compartment arrangements 20, 22 over the longitudinal axis X in severe temperature changes, eliminating buckling and fracturing of the compartment arrangements 20, 22. Stated another way, as the steel portions of the truck frame expand and contract at a much greater rate than the plastic compartments, 20, 22. The attachment assemblies 100 dual-material construction and design allow for greater movement in the steel frame and steel components without requiring the same degree of movement in the the plastic components formed in the assemblies.

The support flange 108 in one example embodiment is made from rigid plastic and is secured to the gussets 104 and 106 and body member 102 by conventional

fasteners (not shown). It should be appreciated by those skilled in the art that the support flange 108 can be held by other forms of attaching polymers and metal together, such as, welding and heat-forming with or without the addition of fasteners.

Expansion of the compartment arrangement 20, 22 along the lateral axis Y is also accommodated (although at a lesser degree) with the polymeric material forming the support flange 108, and the flange plates 111, 112, and 114 in combination with u-shaped slots 122 located in the cross channels 46-52 that extend substantially parallel with the lateral axis Y.

The backing plate 118 is secured to the support plate 110 through a plurality of fasteners 124, as illustrated in FIG. 14. The body 102 is secured to the cross channel 46-52 by fasteners 126, as further illustrated in FIGS. 14 and 15.

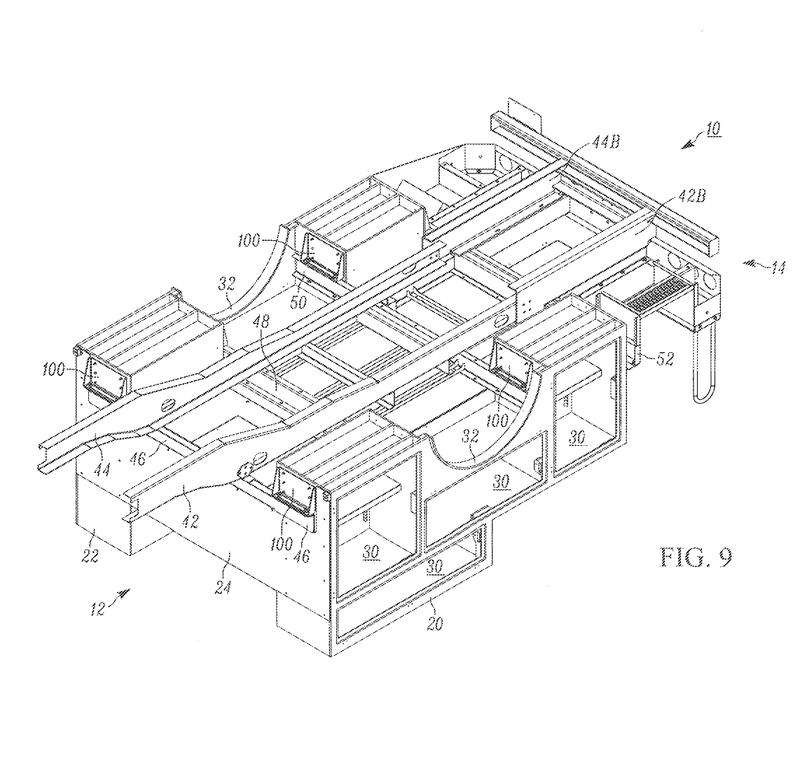

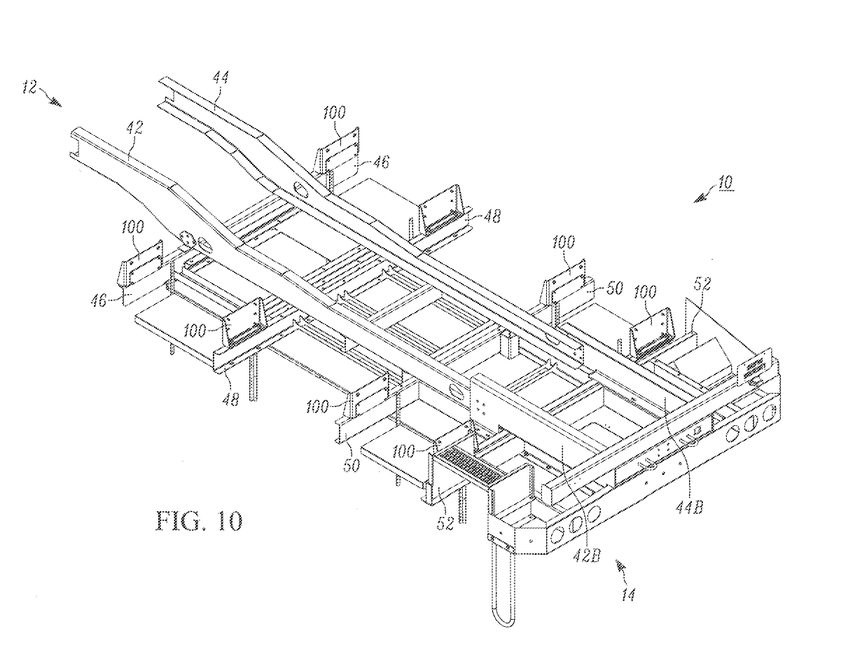

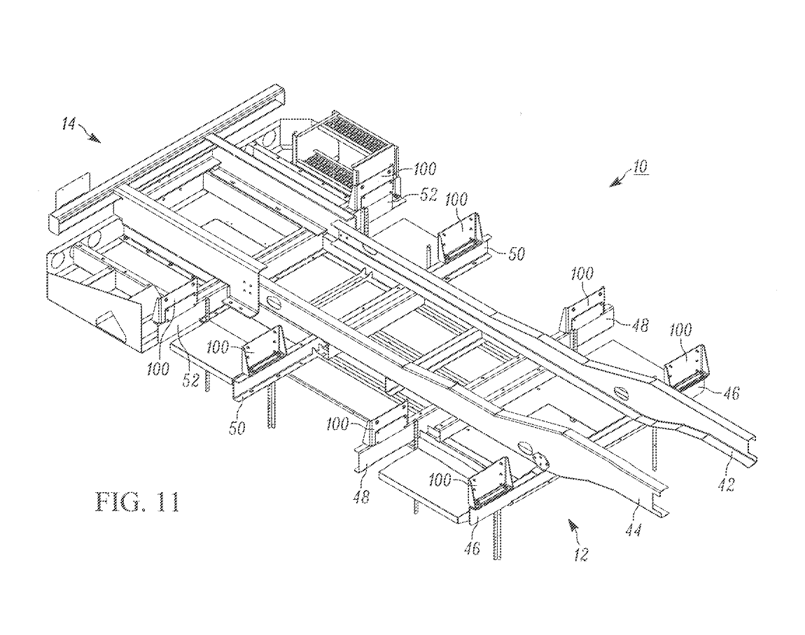

As can be seen, for example in FIG. 11, eight (8) attachment assemblies 100 are attached at opposite lateral ends of the cross channels 46-52. It should be appreciated that more or less attachment assemblies could be used and variations in such numbers used remains within the scope and spirit of the present disclosure. Once the attachment assemblies 100 are fastened to the cross channels 46-52 (as illustrated in FIG. 14), the compartment arrangements 20, 22 are dropped and secured into position as illustrated in FIGS. 8 and 9 through holes 128 and the fasteners 124 passing through the support plate 110 that correspond to fastener holes (not shown) located in the compartment arrangements 20,22.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising, ” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An attachment assembly for securing a polymeric compartment arrangement to a cross channel of a truck bed, the attachment assembly comprising:
a body member transversely extending from a support flange, the support flange comprising first and second slots for engaging a cross channel of a truck bed and said body member having a plurality of apertures for receiving fasteners for securing said body member to a compartment arrangement;
the body member manufactured from a first, material and said support flange manufactured from a second material, wherein said first material is different from said second material.

2. The attachment assembly of claim 1 wherein said first material is metal and said second material is a polymeric material.

3. The attachment assembly of claim 1 wherein said first and second slots are elliptical or u-shaped slots.

4. The attachment assembly of claim 1 wherein a connection formed between said support flange and said body member is further supported by first and second gussets spaced by said support flange.

5. The attachment assembly of claim 1 further comprising first and second flange plates for sandwiching a cross channel of a truck bed when said attachment assembly is secured to a truck bed.

6. The attachment assembly of claim 5 wherein said first and second flange plates are constructed of said second material.

7. The attachment assembly of claim 1 further comprising a backing plate secured to said body member, said backing plate having a plurality of apertures configured to be aligned with said plurality of apertures of said body member.

8. The attachment assembly of claim 7 wherein said backing plate is constructed of said first material.

9. The attachment assembly of claim 1 further comprising a locking plate secured to said support flange, said locking plate having a plurality of apertures configured to be aligned with said first and second slots of said support flange.

10. The attachment assembly of claim 9 wherein said locking plate is constructed of said first material.

11. The attachment assembly of claim 9 wherein said cross channel of said truck bed includes elongated slots, a longitudinal axis of said elongated slots of said cross channel of said truck bed extending substantially perpendicular to a longitudinal axis of said first and second slots of said support flange.

12. An attachment assembly for securing a compartment arrangement to a cross channel of a truck bed, said attachment assembly comprising:
a body member transversely extending from a support flange, said support flange including first and second elongated slots for engaging a cross channel of a truck bed, said body member having a plurality of apertures for securing said body member to a compartment arrangement;
first and second gussets supporting a connection between said body member and said support flange, said support flange spacing said first gusset from said second gusset;
first and second flange plates for sandwiching said cross channel of said truck bed when said attachment assembly is secured to said truck bed, each of said first and second flange plates including elongated slots configured to be aligned with said elongated slots of said support flange;
a backing plate having a plurality of apertures and secured to said body member by first fasteners extending through said apertures of said backing plate, said compartment arrangement, and said apertures of said body member; and
a locking plate engaging at least one of said first and second flange plates, said locking plate including apertures and being secured to said support flange by second fasteners extending through said apertures of said locking plate, said elongated slots of said first and second flange plates, said cross channel of said truck bed, and said elongated slots of the body members;
wherein said compartment arrangement, said support flange, and said first and second flange plates are constructed of a first material, and said cross channel of said truck bed, said body member, said first and second gussets, said backing plate, and said locking plate are made out of a second material, said first material having a different coefficient of thermal expansion than said second material.

13. A method of attaching a polymeric compartment arrangement to a cross channel of a truck bed, the method comprising the steps of:
providing a support flange constructed of a first material and a body member constructed out of a second material, said first material having a different coefficient of thermal expansion than said second material, said body member transversely extending from said support flange;
attaching said support flange to said cross channel of said truck bed; dropping said compartment arrangement into position on said truck bed; and attaching said compartment arrangement to said body member.

14. The method of claim 13 further comprising the step of sandwiching said cross channel of said truck bed and said support flange between a first flange plate and a second flange plate after the step of providing.

15. The method of claim 14 further comprising the step of sandwiching said first flange plate and said second flange plate between a first locking plate and a second locking plate after the step of sandwiching said cross channel of said truck bed and said support flange.

16. The method of claim 13, further comprising the step of securing a backing plate to said body member after the step of dropping.

17. The method of claim 14, wherein said support flange includes first and second slots and said first flange plate and said second flange plate each include first and second slots, and wherein the step of sandwiching said cross channel of said truck bed and said support flange between said first flange plate and said second flange plate further includes concentrically aligning said first and second slots of said support flange with said first and second slots of said first flange plate and said second flange plate.

18. The method of claim 14, wherein said first and second flange plates are constructed out of said first material.

19. The method of claim 15, wherein said first and second locking plates are constructed out of said second material.

20. The method of claim 17, wherein said first and second slots of said support flange have a first longitudinal axis and said cross channel of said truck bed includes elongated slots having a second longitudinal axis, and wherein the step of securing said support flange to said cross channel of said truck bed further includes arranging said first longitudinal axis substantially perpendicular to said second longitudinal axis.
